(19) United States
(12) Patent Application Publication
(10) Pub. No.: US 2026/0158662 A1
(43) Pub. Date: Jun. 11, 2026

(54) SYSTEMS AND METHODS FOR OBJECT PROCESSING WITH PROGRAMMABLE MOTION DEVICES USING LINE GRIPPERS

(71) Applicant: Berkshire Grey Operating Company, Inc., Bedford, MA (US)

(72) Inventors: Jeffrey Ian LIPTON, Sharon, MA (US); Bretton ANDERSON, Westford, MA (US); William Chu-Hyon MCMAHAN, North Cambridge, MA (US); Peter Gerard KELLY, Boston, MA (US)

(21) Appl. No.: 19/410,277

(22) Filed: Dec. 5, 2025

Related U.S. Application Data
(60) Provisional application No. 63/728,946, filed on Dec. 6, 2024.

(51) Int. Cl. B25J 9/16; B25J 15/04; B25J 15/06

(52) U.S. Cl. CPC B25J 9/1697; B25J 15/0441; B25J 15/0483; B25J 15/0491; B25J 15/0683

(57) ABSTRACT

A system and method for processing objects presented at an input area of an object processing system acquires perception data associated with an exposed face of an object, and using the acquired information, determines an appropriate end effector that may be exchanged on a programmable motion device from a selection of a plurality of end-effectors that is particularly suitable for grasping and moving the object to be processed.

### PRIORITY

The present application claims priority to U.S. Provisional Patent Application 63/728,946 filed Dec. 6, 2024, the disclosure of which is hereby incorporated by reference in its entirety.

### BACKGROUND

The invention generally relates to programmable motion systems and relates in particular to end-effectors for programmable motion devices (e.g., robotic systems) for use in object processing systems such as object sortation systems.

End-effectors for robotic systems may be employed, for example, in certain applications to select and grasp an object, and then move the acquired object very quickly to a new location. End-effectors should be designed to quickly and easily select and grasp an object from a jumble of dissimilar objects, and should be designed to securely grasp an object during movement. Certain end-effectors, when used on different objects of different physical sizes, weights and materials, may have limitations regarding how securely they may grasp an acquired object, and how securely they may maintain the grasp on the object during rapid movement, particularly rapid acceleration and deceleration (both angular and linear). Further, in certain applications it may be desired to place an object at a destination in a required orientation or pose, particularly with respect to an environment such as a container being packed by a robotic system.

Many end-effectors employ vacuum pressure for acquiring and securing objects for transport and/or subsequent operations by articulated arms. Other techniques for acquiring and securing objects involve electrostatic attraction, magnetic attraction, needles for penetrating objects such as fabrics, fingers that squeeze an object, hooks that engage and lift a protruding feature of an object, and collets that expand in an opening of an object, among other techniques.

In applications where vacuum pressure is used to acquire and secure objects, an end-effector on an articulated arm may include a vacuum cup having a compliant portion, e.g., a bellows portion that contacts the object to be grasped. The compliant portion may be formed of a polymeric or elastomeric material that is flexible enough to allow it to change its shape to adapt to variations in object surface structures, and to varying physical relationships between the articulated arm and the object, such as for example varying angles of approaches to objects. The flexibility further allows the vacuum cup to conform to the shape of objects or to wrap around corners of objects to create an adequate seal for acquiring and securing the object.

Other types of end-effectors including vacuum cups with less flexible compliant portions (in addition to those using electrostatic attraction, magnetic attraction, needles for penetrating objects such as fabrics, fingers that squeeze an object, hooks that engage and lift a protruding feature of an object, and collets that expand in an opening of an object), are less effective at acquiring and moving a wide variety of objects.

Such applications in which a robotic system needs to accurately process a wide variety of sizes of objects relative to an environment include, for example, packing multi-unit e-commerce orders into a container, packing a single unit into an automated bagging system, packing or consolidating containers used in an automated storage and retrieval system (AS/RS), and scanning objects in front of scanners such as barcode scanners or RFID scanners.

Vacuum end-effectors however, may be limited in their ability to acquire objects of a wide variety of sizes, such as if the objects being processed include small objects such as small sealed books, DVD's, pencils, toys and other small objects, particularly items with widely varying aspect ratios where the automated processing system is unable to control which face of an object is presented to the programmable motion device.

There remains a need therefore, for systems and methods for more efficiently and effectively packing and manipulating objects by efficiently acquiring objects of a wide variety of sizes without adversely impacting throughput.

### SUMMARY

In accordance with an aspect, the invention provides an object processing system with an input area where objects for processing are presented to a programmable motion device. A perception system provides perception data regarding an object to be processed at the input are, where the perception data includes information regarding an exposed face of the object. A processing system determines whether an end-effector attached to the programmable motion device is suitable for grasping and moving the object, based in part on the information regarding the exposed face of the object.

In accordance with another aspect, the invention provides an object processing system with an input area where objects for processing are presented to a programmable motion device and a perception system provides perception data regarding an object to be processed there. The perception data includes information regarding an exposed face of the object and a processing system selects an end-effector to be attached to the programmable motion device for grasping and moving the object based at least in part on the information regarding the exposed face of the object.

In yet another aspect, the invention provides a method of processing objects that includes presenting an object at an input area at which a plurality of objects are presented to a programmable motion device. Then perception data is provided regarding the object to be processed that is at the input area, where the perception data includes information regarding an exposed face of the object. Then, using the information regarding the exposed face of the object, at least in part, an end-effector to be attached to the programmable motion device for grasping and moving the object is exchanged.

### BRIEF DESCRIPTION OF THE DRAWINGS

The following description may be further understood with reference to the accompanying drawings in which:

FIG. 1 shows an illustrative diagrammatic view of an object processing system including a programmable motion device with an end-effector system in accordance with an aspect of the present invention;

FIG. 2 shows an illustrative diagrammatic top view of the object processing system of FIG. 1;

FIG. 3 shows an illustrative diagrammatic enlarged view of the programmable motion device of the object processing system of FIG. 1;

FIG. 4 shows an illustrative diagrammatic further enlarged view of the end-effector of the programmable motion device of FIG. 1;

FIG. 5 shows an illustrative diagrammatic view of the input area of the object processing system of FIG. 1;

FIG. 6 shows an illustrative diagrammatic view of the end-effector of the system of FIG. 1 engaging an object being processed at the input area;

FIG. 7 shows an illustrative diagrammatic view of the end-effector selection rack of the object processing system of FIG. 1;

FIG. 8 shows an illustrative diagrammatic view of various end-effectors for use in the object processing system of FIG. 1;

FIGS. 9A-9D shows illustrative diagrammatic views of an end-effector coupling system for use in the object processing system of FIG. 1 in accordance with an aspect of the present invention, showing a spring-loaded pin on an end-effector attachment portion and an aperture on the end-effector (FIG. 9A), showing the pin proximate the end-effector (FIG. 9B), showing the end-effector attachment portion rotated with respect to the end-effector (FIG. 9C), and showing the pin of the end-effector attachment portion engaging the aperture of the end-effector (FIG. 9D)

FIG. 10 depicts an illustrative diagrammatic exploded view of an end-effector coupling system for use in the object processing system of FIG. 1 in accordance with a further aspect of the present invention, showing an alignment feature in the end-effector and an alignment recess in the end-effector attachment portion;

FIGS. 11A and 11B show illustrative diagrammatic views of an end-effector coupling system in accordance with a further aspect of the invention, showing sets of magnets on each of the end-effector attachment portion and the end-effector (FIG. 11A) and showing the end-effector rotated and attached to the end-effector attachment portion (FIG. 11B);

FIG. 12 shows an illustrative diagrammatic functional view of the operation of an object processing system in accordance with an aspect of the present invention;

FIGS. 13A and 13B show illustrative diagrammatic views of an end-effector in accordance with an aspect of the present invention approaching an object in an object processing system (FIG. 13A) and contacting the object in the object processing system (FIG. 13B);

FIG. 14 shows an illustrative diagrammatic view of an end-effector that includes bellows for use in an accordance with an object processing system of an aspect of the present invention;

FIG. 15 shows an illustrative diagrammatic view of another end-effector that includes bellows for use in an accordance with an object processing system of an aspect of the present invention;

FIG. 16 shows an illustrative diagrammatic view of an end-effector that includes an internal open lattice structure for use in an accordance with an object processing system of an aspect of the present invention;

FIG. 17 shows an illustrative diagrammatic view of the end-effector of FIG. 16 shown without its external skin;

FIG. 18 shows an illustrative diagrammatic top view of the end-effector of FIG. 16;

FIG. 19 shows an illustrative diagrammatic view of the end-effector of FIG. 16 without its external skin shown bent;

FIG. 20 shows an illustrative diagrammatic view of an end-effector that includes a cylindrical internal open lattice structure for use in an accordance with an object processing system of an aspect of the present invention;

FIG. 21 shows an illustrative diagrammatic view of the end-effector of FIG. 20 shown without its external skin;

FIG. 22 shows an illustrative diagrammatic top view of the end-effector of FIG. 20;

FIG. 23 shows an illustrative diagrammatic view of the end-effector of FIG. 20 without its external skin shown bent;

FIG. 24 shows an illustrative diagrammatic view of an end-effector that includes an oval-shaped internal open lattice structure for use in an accordance with an object processing system of an aspect of the present invention shown without its skin; and

FIG. 25 shows an illustrative diagrammatic view of the end-effector of FIG. 24 without its external skin shown bent.

The drawings are shown for illustrative purposes.

### DETAILED DESCRIPTION

In accordance with various aspects, the invention provides an end-effector system for programmable motion devices (e.g., robotic systems) that provides high flow vacuum to grasp objects. The high flow vacuum is provided at an end-effector vacuum cup of the robotic system, and the vacuum cup is coupled to a high flow vacuum system. The vacuum cup is attached to a cup attachment portion, which is in turn attached to an arm attachment portion that is attached to an articulated arm of the robotic system.

Object processing systems in accordance with various aspects of the invention employ any of a variety of high flow vacuum cups that are used for different objects during object processing as discussed herein. A challenge with using high flow vacuum is that if the vacuum cup contact surface contacts plural objects, the plural objects may all be grasped because the high flow vacuum system does not require that the vacuum cup tightly seal a closed surface of the object being grasped. Using a vacuum cup therefore that contacts plural objects may well grasp all of the plural objects using the high flow vacuum. Further, while in certain applications it may be advantageous for the vacuum cup to be flexible, any compressibility of the vacuum cup may become problematic if the vacuum force collapses the vacuum cup in certain applications.

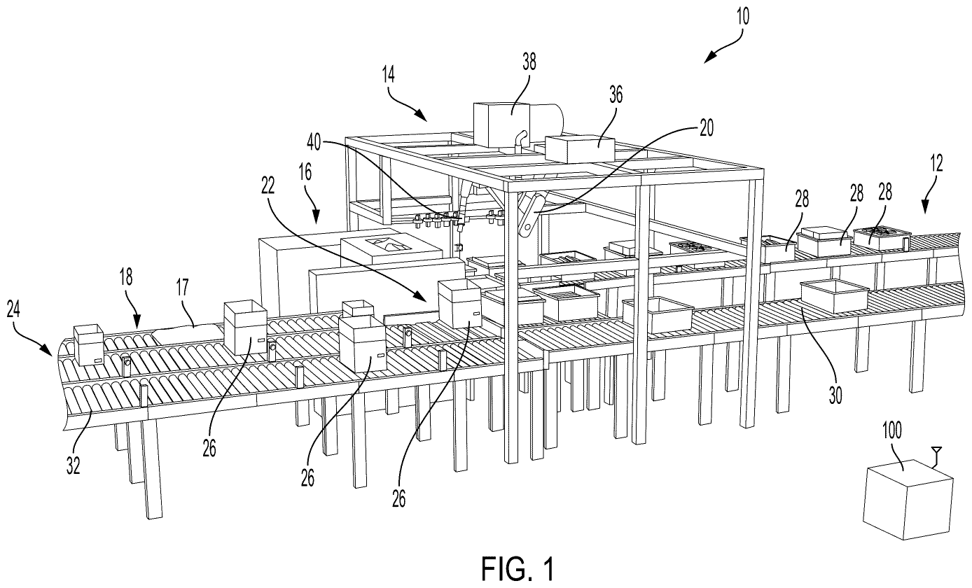

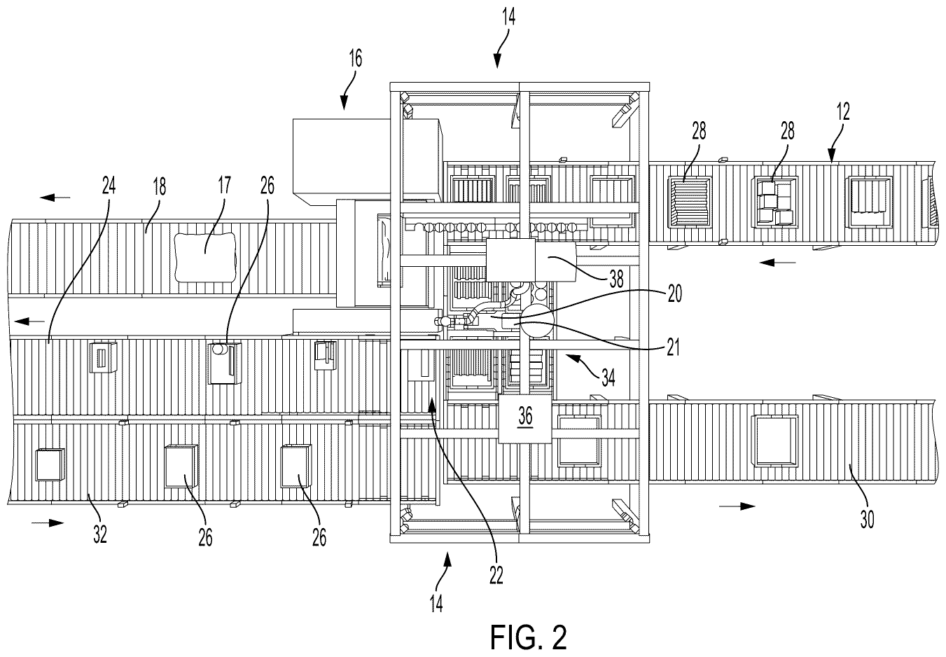

FIG. 1 shows an object processing system 10 in accordance with an aspect of the present invention that includes an input source conveyor 12 that provides objects to be processed to a processing station 14 that includes a programmable motion device 20. The programmable motion device 20 is used to grasp and move objects received at an input area 34 (shown in FIG. 2) from the input source conveyor 12, and to provide objects to any of an auto-bagging system 16 that provides objects in sealed bags 17 along an auto-bagging system conveyor 18, or to provide objects to output containers 26 (e.g., shipping boxes) provided at a packing area 22 on an container output conveyor 24. The objects to be processed may be provided in input source containers 28.

With further reference to FIG. 2, a top view shows the input source conveyor 12 that brings input objects (e.g., in bins 28) to the input area 34. The input area 34 include two conveyor sections that receive objects from the input source conveyor 12, and both conveyor sections lead to a source container return conveyor 30 as shown in FIG. 2. Empty output containers 26 are provided along an empty output container conveyor 32 to the processing station 14, and are routed to the packing area 22 where they are packed prior to being moved along the container output conveyor 24. Operation of the conveyors and other components of the system is provided by the one or more computer processing systems 100 as discussed herein, and the programmable motion device may include its own processing control system 36 in communication with the one or more computer processing systems 100.

With reference again to FIG. 1, the programmable motion device 20 includes an end-effector attachment portion (shown in more detail in FIG. 4) that is coupled to a high flow vacuum source 38, such as for example, a side-channel blower, air amplifiers or multistage ejectors. The high flow vacuum source 38 may, for example, provide at the end-effector attachment portion 40 an air flow of at least about 100 cubic feet per minute, and a vacuum pressure of no more than about 100,000 Pascals below atmospheric, or no more than about 85,000 Pascals below atmospheric, or no more than about 65,000 Pascals below atmospheric. Again, the use of such a high flow vacuum source, while providing benefits in grasping objects where a seal is not tightly formed between the vacuum cup and the object, presents challenges in grasping only one object among a plurality of objects.

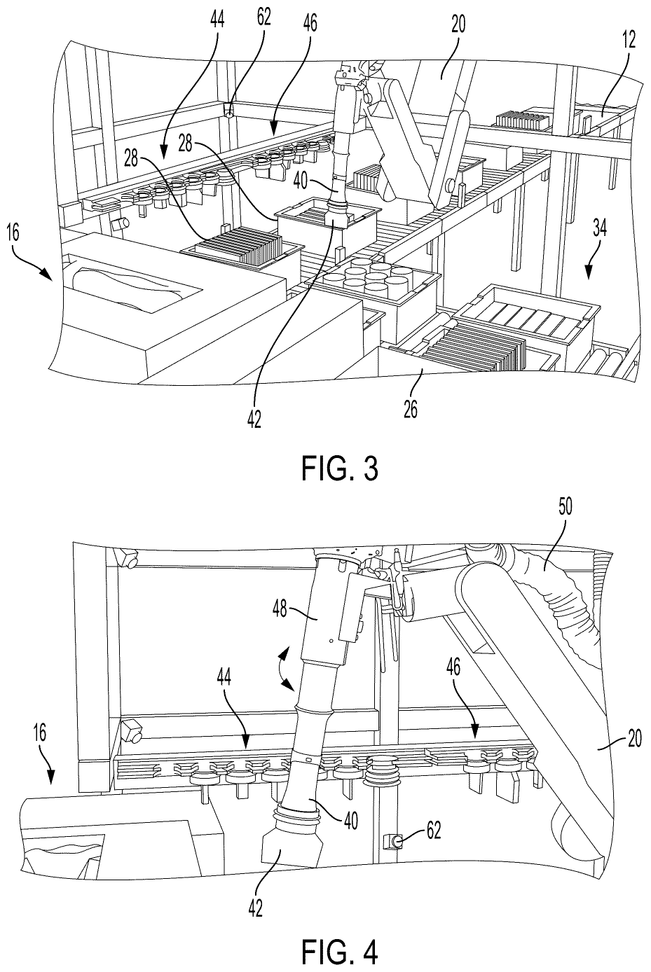

With reference to FIG. 3, an end-effector 42 may be attached to the end-effector attachment portion 40 of the programmable motion device. Plural additional end-effectors may be provided on one or more end-effector racks 44, 46 as further shown in FIG. 4. The programmable motion device is programmed to be able to engage and disengage any of the end-effectors on the racks 44, 46 as further discussed below. The end-effector attachment portion 40 is mounted within a collar 48 that is attached to the programmable motion device 20, and an opposite end of the end-effector attachment portion (that extends out the other side of the collar 48) is coupled to a vacuum hose 50 that is coupled to the vacuum source 38.

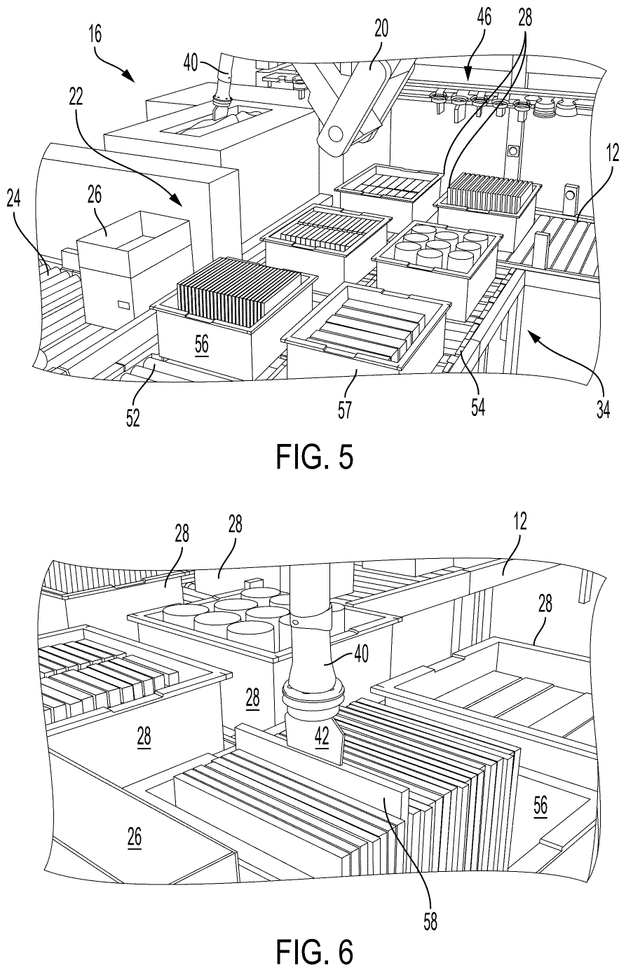

As shown in FIG. 5, exemplary objects to be processed by the system may come in a variety of sizes with a variety of exposed face sizes available for grasping. The input area 34 in FIG. 5 includes the two conveyor sections 52, 54, both of which may be accessed by the end-effector of the programmable motion device. In certain applications, each conveyor section may further include right-angle-transfer mechanisms (e.g., raisable belts) to move containers between the conveyor sections 52, 54. An input container, e.g., container 56) may include objects with a large aspect ratio but with small-sized faces exposed to the programmable motion device. In accordance with an aspect of the present invention, the system may select an end-effector (e.g., 42) to be used to grasp an object 58 from the input container 56 as shown in FIG. 6.

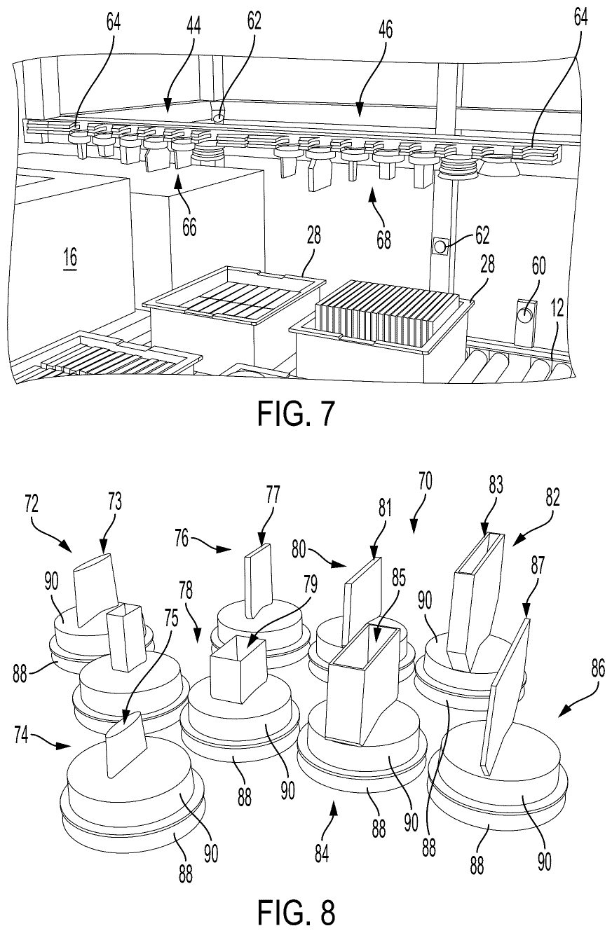

FIG. 7 shows the end-effector racks 44, 46 positioned such that the programmable motion device (not shown in FIG. 7 for clarity) may access any of the end-effectors on the racks. Each end-effector rack 44, 46 includes a rack structure 64 as well as any of a plurality of available end-effectors 66, 68 on the rack structures 64. As also shown in FIG. 7, the system may include conveyor perception units 60 along the input source conveyor 12 as well as perception units 62 on the support structure from which the programmable motion device is suspended for aiding (together with the computer processing systems 36, 100) in operation of the programmable motion device of grasping, moving and placing objects into any of, for example, output containers 26 or sealed bags 17 as discussed herein. A perception system (e.g., including perception units 62 and perception unit 21 shown in FIG. 2) provide perception data regarding an object to be processed that is in the input area, and the perception data includes data that is representative of an exposed face of the object.

FIG. 8 shows an enlarged view of many such end-effectors 70, including end-effectors 72, 74, 76, 78, 80, 82, 84, 86 for use in various applications. Each of the end-effectors 70 include a mounting structure (e.g., an annular mounting ring 88) for engagement with the rack structures 64 and for engagement with end-effector attachment portion 40 of the programmable motion device 20. Each of the end-effectors 70 also include a coupling cover 90 that is attached to each annular mounting ring 88 as well as to each vacuum applicator. Each vacuum applicator (e.g., vacuum cup) has a vacuum application face that is larger in one dimension that in another dimension that is orthogonal to the first dimension. For example, the vacuum applicator of the end-effector 72 has an application face 73 that is oval shaped and is much longer than it is wide, while the vacuum applicator of the end-effector 74 has an application face 75 that is also oval-shaped but is shorter and wider than the vacuum applicator of the end-effector 72. The application faces 77-87 of the vacuum applicators of the end-effectors 76-86 respectively are generally rectangular-shaped, each having varying widths and lengths, and all providing open passage of a vacuum through the vacuum applicator and the coupling cover 90. In each end-effector therefore, the application face includes dimensions in each of first and second mutually orthogonal directions. A particular narrow application face may, for example, have a shortest dimension of one or two mm, and a largest dimension of fifty or sixty mm. As herein discussed, each vacuum applicator has an application face with a known shortest dimension (C0) and a known largest dimension (C1), and when each end-effector is placed onto a rack structure, the location of the end-effector is recorded (loc).

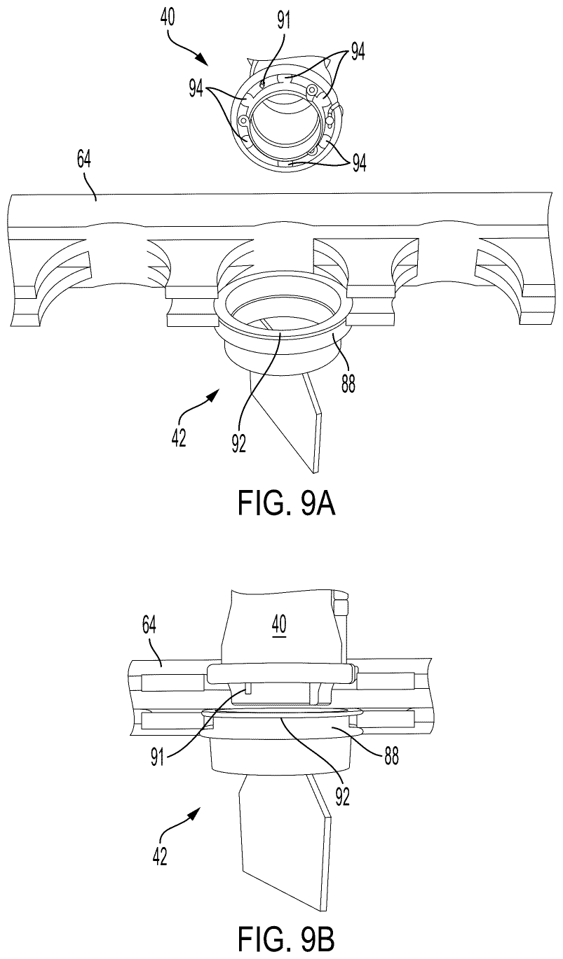

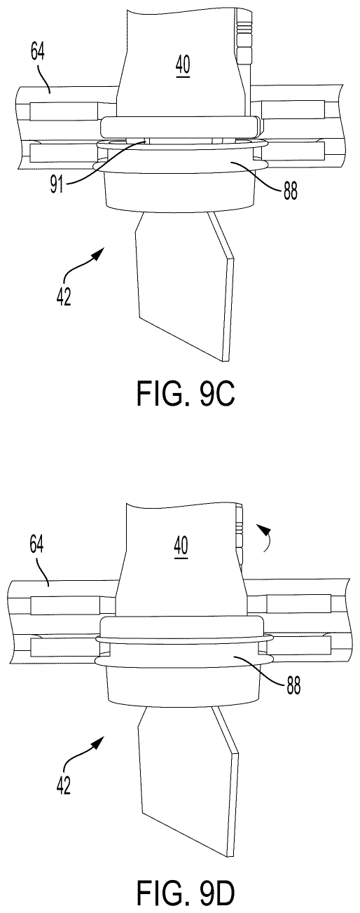

The coupling of each end-effector 42 to the end-effector attachment portion 40 may be provided, for example, by engaging magnets on one part with a ferromagnetic metal (or complementary magnets) of the other part. Because the dimensions C0 and C1 of each vacuum applicator are different (C0≠C1), the system needs to engage each end-effector at an orientation that is known. FIGS. 9A-9D for example, show an engagement system that includes a pin and a pin recess for alignment of the end-effector on the attachment portion. With reference to FIG. 9A, a spring-loaded pin 91 is provided on the attachment portion, and a pin recess 92 is provided on the annular mounting ring 88. During use in attaching the end-effector 42 to the attachment portion 40, the programmable motion device positions the attachment portion 40 above the desired end-effector on the rack, wherein the pin 91 and the recess 92 are not yet aligned (FIG. 9B). The attachment portion is lowered further, and the pin contacts the annular mounting ring 88 (FIG. 9C). The end-effector attachment portion is then rotated until the pin 91 engages the pin recess 92 (FIG. 9D). The retracted position of the pin 91 (shown in FIG. 9C) is designed such that the magnetic fields of the magnets 94 are not yet so strong as to inhibit rotation of the attachment portion with respect to the end-effector. In accordance with further aspects, the magnets 94 may be provided as electromagnets that may be engaged only when the pin has been received within the pin recess (FIG. 9D). In this example, the attachment portion rotates until it is aligned with the end-effector on the rack.

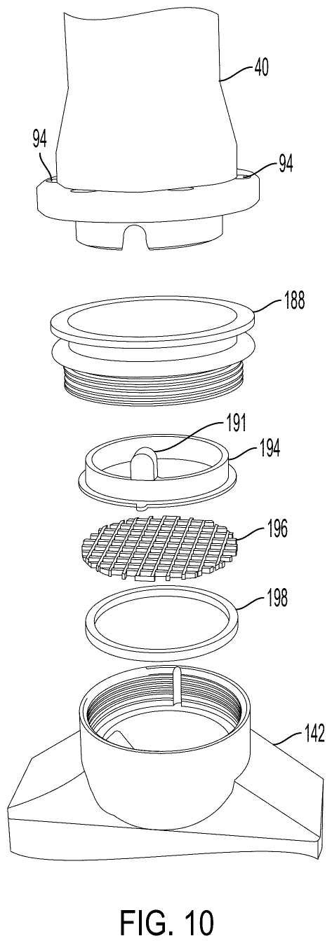

In accordance with another aspect, alignment of the coupling of each end-effector 42 to the end-effector attachment portion 40 is provided by an alignment feature 191 that engages with an alignment recess 192 provided in the end-effector attachment portion when rotationally aligned, as depicted in an exploded view as shown in FIG. 10. The alignment feature 191 may be provided on an insert 194 that is captured within the end-effector 142 with the annular mounting ring 188 that is threaded into a threaded receptacle of the end-effector 142. An o-ring 198 may be provided to minimize vacuum leakage through the threads of the threaded annular mounting ring 188 and the end-effector 142. Furthermore, a mesh screen insert 196 may be optionally provided to minimize the potential for introducing debris into the vacuum system during operation. During use in attaching the end-effector 142 to the attachment portion 40, the programmable motion device positions the attachment portion 40 above the desired end-effector on the rack, without a priori knowledge of the orientation of the desired end-effector in the rack. The attachment portion 40 is lowered, and if the alignment is not established, the alignment feature 191 fails to engage in the alignment recess 192, causing resistance to movement. The programmable motion device then rotates the attachment portion 40 until the resistance is minimized, where the alignment feature 191 engages into the alignment recess 192 causing the magnets 94 (described above) to provide the attachment force attaching the end-effector 142 to the attachment portion 40.

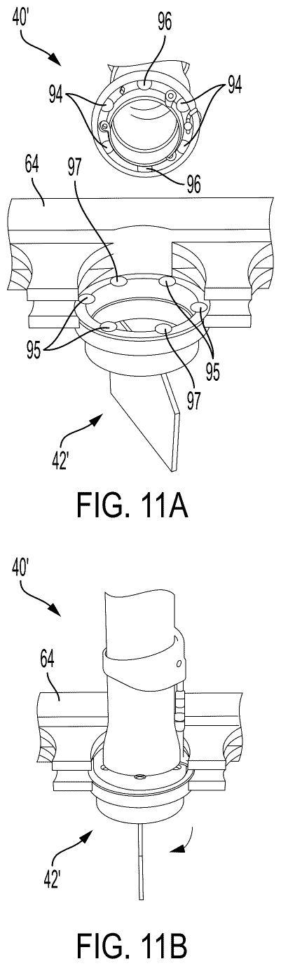

In accordance with further aspects, the magnets used for engaging the attachment portion to the annular attachment ring of the end-effector may themselves effect proper alignment of the end-effector with the attachment portion. FIGS. 11A and 11B, for example, show another attachment portion 40′ and end-effector 42′ that include a plurality of magnets. In particular the attachment portion 40′ includes s-magnets 94 and n-magnets 96, while the end-effector 42′ includes n-magnets 95 and s-magnets 97. FIG. 11A shows the magnets, and FIG. 11B shows the attachment portion 40′ coupled to the end-effector 42′, showing that the end-effector 42′ has been rotated under the polar forces of the magnets to both align with and engage the end-effector 42′ with the attachment portion 40′. The n-magnets align with the s-magnets, so irrespective of the original orientation of the end-effector with respect to the attachment portion, the parts will come together in one of either of two mutual orientations that are 180° apart; either of these mutual orientations works because the end-effectors are symmetric. In accordance with further aspects, sets of magnets may be used that couple only in a single respective orientation of each end-effector and the attachment portion. In accordance with certain aspects, the attachment portion 40′ may also (or instead) be rotated to the alignment position. In each of the systems of FIGS. 9A-11B , the control system may know or confirm the identity of each end-effector either by a scanner or camera system that detects a code on each end-effector or by providing low level magnets that detect low level distinct field patterns identifying each end-effector.

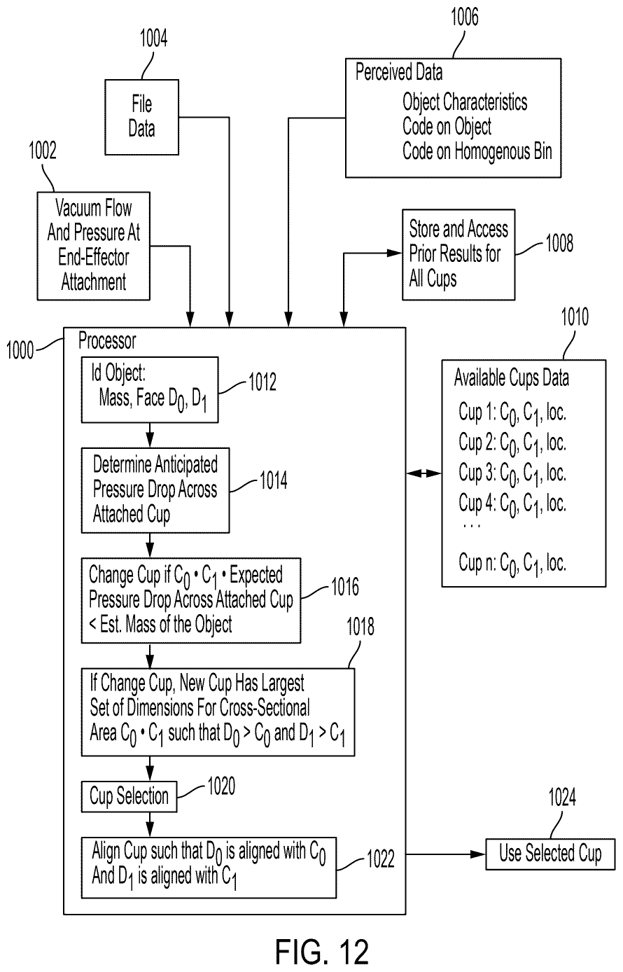

With reference to FIG. 12, operation of object processing systems is shown in accordance with certain aspects of the invention (e.g., using the one or more computer processing systems 36, 100) that include using a processor 1000 that receives input information (shown at 1002) regarding vacuum flow and pressure at the distal end of the end-effector attachment portion, and receives file data (shown at 1004) regarding object dimensions and weight of a wide variety of objects that are expected to be encountered. The processor 1000 also receives data regarding perceived data 1006, including information from perception systems (e.g., 60, 62) regarding characteristics of an object, any identifying code on an object, and any identifying code on a homogenous input bin 28. This information may be used in association with the file data to determine information about each object to be grasped. The processor 1000 also stores and receives data (shown at 1008) regarding prior grasp attempts (successful and not successful) of a variety of objects using different end-effectors. The processor 1000 further receives available cup data (shown at 1010) regarding each of the available vacuum applicators (e.g., cups 1-n) that includes the smallest dimension of the applicator face of each vacuum applicator (C0), the largest dimension of the applicator face of each vacuum applicator (C1), and the location of each vacuum applicator on any of the racks 64 (loc.).

The processor 1000 uses these data to perform a series of operations including the following. The system will identify a selected object to be grasped, and for the selected object, determine the mass of the object, and the largest and smallest dimensions of the exposed face of the object (shown at 1012). The system will then determine whether the (currently) attached vacuum cup may be used to grasp and move the object (if so, this saves time). The system determines the anticipated pressure drop across the attached cup (shown at 1014) and if the anticipated pressure drop across the attached cup is less than the estimated mass of the object, the system will determine that the cup needs to be changed (shown at 1016). Where the cup needs to be changed, the system will then identify a new cup that has a largest set of dimensions for cross-sectional area C0• C1 such that D0>C0 and D1>C1 (shown at 1018). The new cup is selected (shown at 1020) and the new cup is aligned with the object such that D0 is aligned with C0 and D1 is aligned with C1 (shown at 1022). The system then uses the newly attached and aligned cup to grasp and move the selected object (shown at 1024).

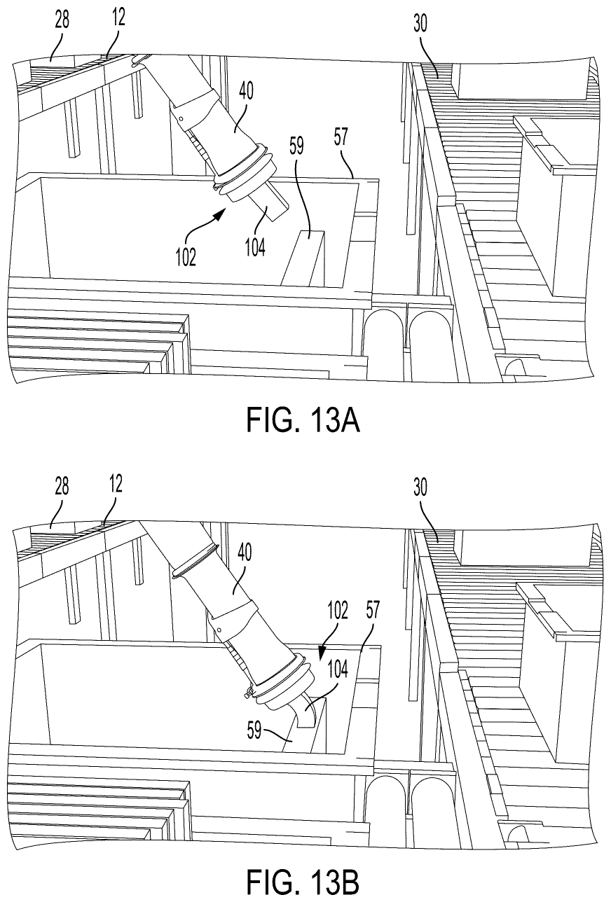

The material used for the vacuum applicators (cups) may be flexible polymeric or elastomeric material that accommodates any variations on a grasped surface on an object. Additionally, when using the high flow vacuum, any flexibility of the cups may facilitate the ability of the vacuum cup to find the surface of the object in situations where a portion of the applicator face is in close proximity to the object (e.g., where approaching an object from a direction far off from normal). FIG. 13A, for example, shows the attachment portion 40 of the programmable motion device with an attached end-effector 102 having a vacuum applicator (cup) 104 that has been selected for grasping an object 59 in input bin 57. In this example, the vacuum applicator 104 is formed of a flexible elastomeric material, and as the end-effector 102 nears the object 59 from an oblique angle, the high flow vacuum force may be drawn to the object 59, causing the vacuum applicator 104 to bend toward the object as shown in FIG. 13B.

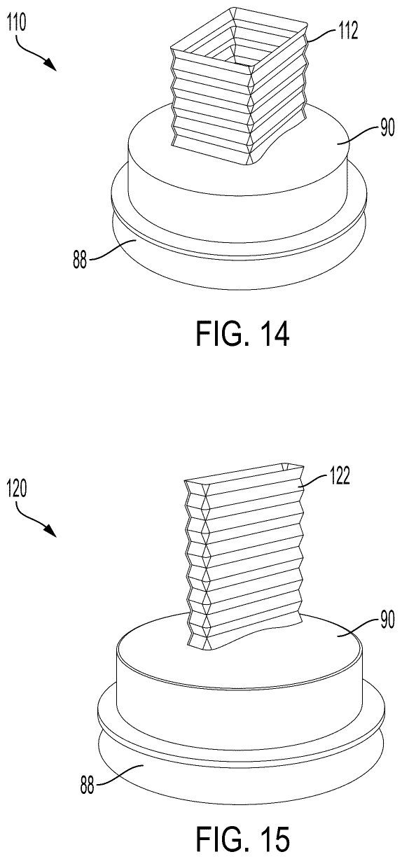

Any flexibility of the vacuum applicator may be provided by material used and/or may be provided by the structure of the vacuum applicator. FIGS. 13 and 14 show end-effectors 110 and 120 that are each mounted on a coupling cover 90 on an annular mounting ring 88 as discussed above. The end-effector 110 of FIG. 14 includes a vacuum applicator 112 formed of a bellows having a rectangular-shaped application face with shortest and longest dimensions that are different but not significantly different. The end-effector 120 of FIG. 15 includes a vacuum applicator 122 formed of a bellows having a rectangular-shaped application face with shortest and longest dimensions that are significantly different. The extension length of each vacuum applicator may also be adjusted to provide a desired bendability, but collapsibility of such vacuum applicators may become a concern in certain applications. The design of these vacuum applicators (cups) and bellows clearly maximizes the cross-sectional area of the duct connecting the cup to the vacuum source. This allows for non-conforming, imperfect and leaky interface from gripper to item. The materials and shapes of the bellows may be chosen to provide a slight deformation only over a range of applications involving certain vacuum pressures and flows for certain types of objects. If, however, the bellows collapse under the force of an object being held at the application face, the actual position of the object may be lost to the processing system, and/or the object may become dislodged from the vacuum applicator.

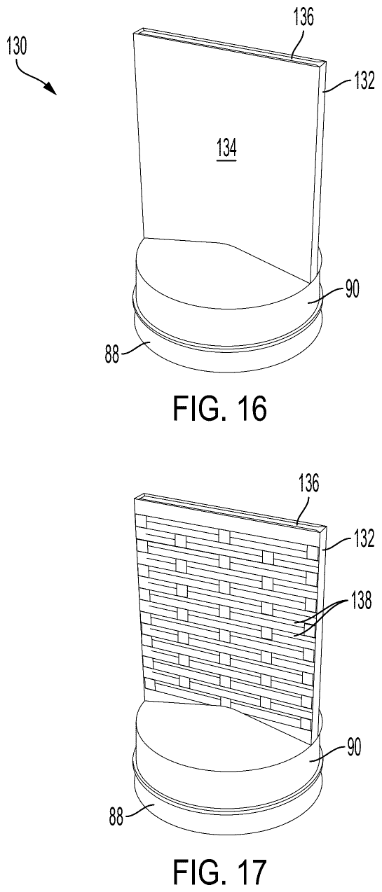

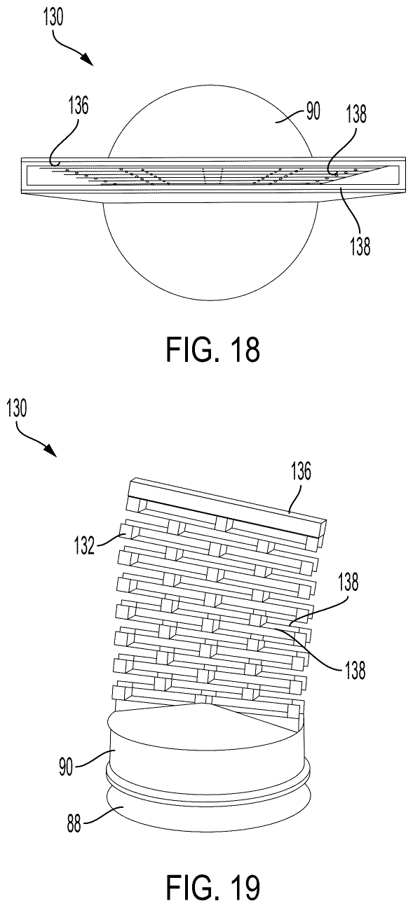

In accordance with further aspects, vacuum applicators of end-effectors of certain aspects of the invention may include structure that includes linkages or tiling of a series of flexures to create a flexible structure that resists compression yet provides bendability of the vacuum applicator. FIG. 16, for example, shows an end-effector 130 that includes a vacuum applicator 132 that includes a flexible rubber skin 134 on the outside of a set of two non-compressible flexure structures that permit passage of the high flow vacuum between the flexure structures. FIG. 17 shows the rubber skin 134 removed, exposing the two flexure structures 138, and FIG. 18 shows a top view of a rectangular face 136 of the vacuum applicator 132, where the vacuum passage to the face is provided between the two flexure structures 138. With reference to FIG. 19, while the flexure structures 138 permit the vacuum applicator 132 to bend, they resist compression of the vacuum applicator 132 in the longitudinal (vacuum-flow) direction. The design of the lattice structure of the bellows may further provide different stiffnesses in different areas (e.g., directions) to achieve different compression characteristics. For example, if the center were more stiff to compression, than the sides, then the business end of the gripper may free to change its angle along the length while resisting the tendency to buckle in the short direction. Through design, therefore, the stiffness about one axis could be different from the stiffness about another axis (roll vs pitch).

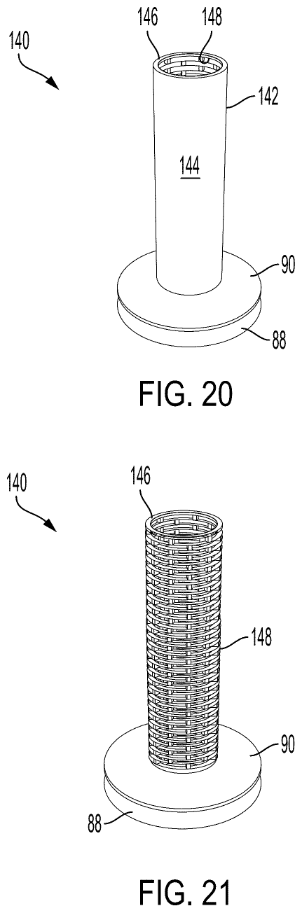

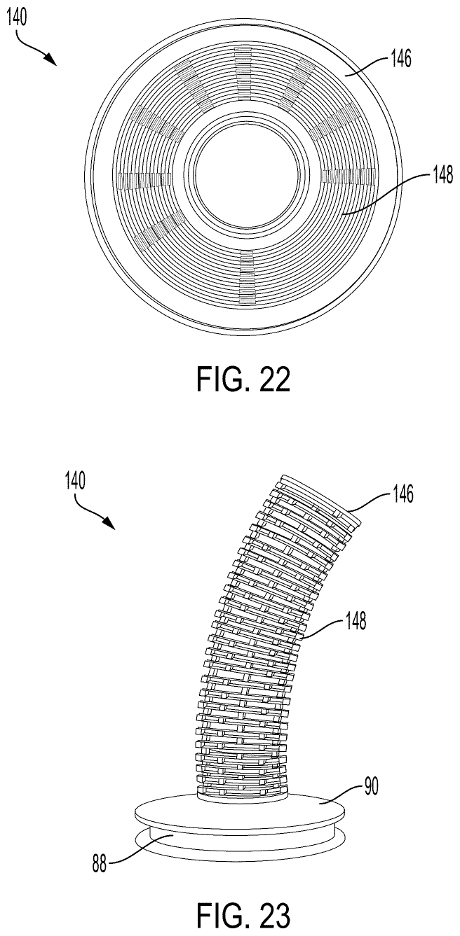

Similarly, FIG. 20 shows an end-effector 140 that includes a vacuum applicator 142 that includes a flexible rubber skin 144 on the outside of a cylindrical flexure structure 148 that includes a narrow-cross section and permits passage of the high flow vacuum within the cylindrical flexure structure 148. FIG. 21 shows the rubber skin 144 removed, exposing the cylindrical flexure structure 148, and FIG. 22 shows a top view of the circular face 146 of the vacuum applicator 142, where the vacuum passage to the face is provided within the cylindrical flexure structures 148. With reference to FIG. 23, while the flexure structure 148 permits the vacuum applicator 142 to bend, it resists compression of the vacuum applicator 142 in the longitudinal (vacuum-flow) direction. Again, the design of the lattice structure of the bellows may further provide different stiffnesses in different areas (e.g., radial directions) to achieve different compression characteristics such as different roll and pitch.

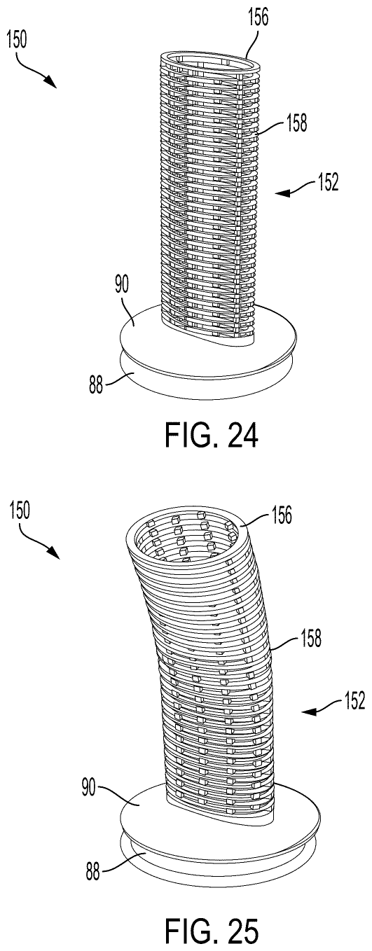

FIG. 24 shows an end-effector 150 that includes a vacuum applicator 152 that includes a flexible rubber skin on the outside of an oval-shaped cylindrical flexure structure 158 that permits passage of the high flow vacuum within the oval-shaped cylindrical flexure structure 158. FIG. 24 shows the rubber skin removed, exposing the oval-shaped cylindrical flexure structure 158, showing the oval-shaped face 156 of the vacuum applicator 152, where the vacuum passage to the face is provided within the oval-shaped cylindrical flexure structures 158. With reference to FIG. 25, while the flexure structure 158 permits the vacuum applicator 152 to bend, it resists compression of the vacuum applicator 152 in the longitudinal (vacuum-flow) direction. Again, the design of the lattice structure of the bellows may further provide different stiffnesses in different areas (e.g., radial directions) to achieve different compression characteristics such as different roll and pitch.

Those skilled in the art will appreciate that numerous modifications and variations may be made to the above disclosed embodiments without departing from the spirit and scope of the present invention.

What is claimed is:

1. An object processing system comprising:
an input area at which objects for processing are presented to a programmable motion device;
a perception system providing perception data regarding an object to be processed that is at the input area, said perception data including information regarding an exposed face of the object; and
a processing system for determining whether an end-effector attached to the programmable motion device is suitable for grasping and moving the object based at least in part on the information regarding the exposed face of the object.

2. The object processing system of claim 1, wherein the processing system further selects an end-effector to be attached to the programmable motion device for grasping and moving the object based at least in part on the information regarding the exposed face of the object.

3. The object processing system of claim 1, wherein the end-effector includes an applicator face that includes dimensions in first and second mutually orthogonal directions that are different dimensions.

4. The object processing system of claim 3, wherein the applicator face provides for passage of a high flow vacuum therethrough.

5. The object processing system of claim 1, wherein the end-effector is aligned with an attachment portion of the programmable motion device using an alignment feature and recess combination structure.

6. The object processing system of claim 5, wherein the alignment feature and recess combination structure comprises a pin and a pin recess.

7. The object processing system of claim 1, wherein the end-effector is aligned with an attachment portion of the programmable motion device using a plurality of magnets.

8. The object processing system of claim 1, wherein the end-effector includes a vacuum applicator that is flexible.

9. An object processing system comprising:
an input area at which objects for processing are presented to a programmable motion device;
a perception system providing perception data regarding an object to be processed that is at the input area, said perception data including information regarding an exposed face of the object; and
a processing system for selecting an end-effector to be attached to the programmable motion device for grasping and moving the object based at least in part on the information regarding the exposed face of the object.

10. The object processing system of claim 9, wherein the processing system further determines whether an end-effector attached to the programmable motion device is suitable for grasping and moving the object based at least in part on the information regarding the exposed face of the object.

11. The object processing system of claim 9, wherein the end-effector includes an applicator face that includes dimensions in first and second mutually orthogonal directions that are different dimensions.

12. The object processing system of claim 11, wherein the applicator face provides for passage of a high flow vacuum therethrough.

13. The object processing system of claim 9, wherein the end-effector is aligned with an attachment portion of the programmable motion device using an alignment feature and recess combination structure.

14. The object processing system of claim 9, wherein the end-effector is aligned with an attachment portion of the programmable motion device using a plurality of magnets.

15. The object processing system of claim 9, wherein the end-effector includes a vacuum applicator that is flexible.

16. A method of processing objects comprising:
presenting an object at an input area at which a plurality of objects are presented to a programmable motion device;
providing perception data regarding the object to be processed that is at the input area, the perception data including information regarding an exposed face of the object; and
exchanging an end-effector to be attached to the programmable motion device for grasping and moving the object based at least in part on the information regarding the exposed face of the object.

17. The method of claim 16, wherein the method further includes determining whether an end-effector attached to the programmable motion device is suitable for grasping and moving the object based at least in part on the information regarding the exposed face of the object.

18. The method of claim 16, wherein the method further includes selecting an end-effector to be attached to the programmable motion device for grasping and moving the object based at least in part on the information regarding the exposed face of the object.

19. The method of claim 16, wherein the end-effector includes an applicator face that includes dimensions in first and second mutually orthogonal directions that are different dimensions.

20. The method of claim 19, wherein the applicator face provides for passage of a high flow vacuum therethrough.
